(19) United States
(12) Patent Application Publication
(10) Pub. No.: US 2013/0268421 A1
(43) Pub. Date: Oct. 10, 2013

(54) Dynamic Agricultural Index Methodology

(71) Applicants: K. Geert ROUWENHORST, New Haven, CT (US); Adam Dunsby, Easton, CT (US); Kurt J. Nelson, Norwalk, CT (US); Ashraf R. Rizvi, New Canaan, CT (US)

(72) Inventors: K. Geert ROUWENHORST, New Haven, CT (US); Adam Dunsby, Easton, CT (US); Kurt J. Nelson, Norwalk, CT (US); Ashraf R. Rizvi, New Canaan, CT (US)

(73) Assignee: SUMMERHAVEN INVESTMENT MANAGEMENT, LLC, Stamford, CT (US)

(21) Appl. No.: 13/665,535

(22) Filed: Oct. 31, 2012

Related U.S. Application Data
(60) Provisional application No. 61/628,418, filed on Oct. 31, 2011.

(51) Int. Cl. G06Q 40/04; G06Q 50/02

(52) U.S. Cl. CPC G06Q 40/04; G06Q 50/02
USPC 705/37

(57) ABSTRACT

A computer-generated dynamic agricultural index of value to investors is determined from a rules-based weighted assessment of market liquidity and economic importance of fourteen agricultural markets of soybeans, corn, soft red winter wheat, hard red winter wheat, soybean oil, soybean meal, canola, sugar, cocoa, coffee, cotton, live cattle, feeder cattle and lean hogs.

### CROSS-REFERENCE TO RELATED APPLICATION

This application derives from U.S. Provisional Application Ser. No. 61/628,418, filed Oct. 31, 2011, the contents of which is incorporated herein by reference and the priority of which is hereby claimed.

### BACKGROUND OF INVENTION

### Field of Intention

This invention relates to the determination, using a computer, of a dynamic agriculture index that is of value to investors in making decisions regarding the advisability of investing in agricultural commodities.

### SUMMARY OF THE INVENTION

The inventive agriculture index is an agricultural sector index designed to broadly represent major agricultural commodities while overweighting the components that are assessed to be in a low inventory state and underweighting the components assessed to be in a high inventory state.

The Agriculture Index consists of fourteen agricultural markets: soybeans, corn, soft red winter wheat, hard red winter wheat, soybean oil, soybean meal, canola, sugar, cocoa, coffee, cotton, live cattle, feeder cattle and lean hogs. Each agricultural commodity is assigned a base weight based on an assessment of market liquidity and the commodity's overall economic importance. Each commodity is U.S. dollar based, with the exception of canola, which is quoted in Canadian dollars and converted to U.S. dollars for the purpose of the Agriculture Index calculation.

Academic research by Professors Gorton, Rouwenhorst and Hayashi has shown that commodities in relatively low inventory states tend to have higher returns than commodities in relatively high inventory states. Furthermore, relative inventory comparisons can be estimated by the price-based signals momentum and basis. Momentum is the percentage price change in a commodity over the previous year. Basis is the annualized percentage difference between the nearest-to-maturity contract and the second nearest-to-maturity contract. Using these price-based signals, agricultural commodities determined to be in low inventory state will be weighted more heavily, and agricultural commodities in high inventory state will be weighted less heavily during any given month.

The Agriculture Index is rules-based and rebalanced monthly based on observable price signals described above. In this context, the term “rules-based” is meant to indicate that the composition of the Agriculture Index in any given month will be determined by quantitative formulas relating to the prices of the futures contracts that relate to the commodities that are included in the Agriculture Index. Such formulas are not subject to adjustment based on other factors.

The overall return on the Agriculture Index is generated by two components: (i) uncollateralized returns from the Benchmark Component Agriculture Futures Contracts comprising the Agriculture Index and (ii) a daily fixed income return reflecting the interest earned on a hypothetical 3-month U.S. Treasury Bill collateral portfolio, calculated using the weekly auction rate for the 3-Month U.S. Treasury Bills published by the U.S. Department of the Treasury. SummerHaven Indexing is the owner of the Agriculture Index.

Table I below lists the eligible agricultural commodities, the relevant Futures Exchange on which each Benchmark Component Agriculture Futures Contract is listed and quotation details. Table 2 lists the Benchmark Component Agriculture Futures Contracts, their sector designation and maximum allowable tenor.

TABLE 1

| Commodity | Designate Contract | Exchange | Units | | Quotes |
|---|---|---|---|---|---|
| Soybeans | Soy beans | CBOT | 5,000 | bushels | U.S. cents/bushel |
| Corn | Corn | CBOT | 5,000 | bushels | U.S. cents/bushel |
| Soft Red Winter Wheat | Soft Red Winter Wheat | CBOT | 5,000 | bushels | U.S. cents/bushel |
| Hard Red Winter Wheat | Hard Red Winter Wheat | KCBT | 5,000 | bushels | U.S. cents/bushel |
| Bean Oil | Bean Oil | CBOT | 60,000 | lbs. | U.S. cents/Pound |
| Soybean Meal | Soybean Meal | CBOT | 100 | Tons | USD/ton |
| Coffee | Coffee “C” | ICE-US | 37,500 | lbs. | U.S. cents/pound |
| Cocoa | Cocoa | ICE-US | 10 | metric tons | USD/metric ton |
| Sugar | World Sugar No. 11 | ICE-US | 112,000 | lbs. | U.S. cents/pound |
| Canola | Canola | ICE-CANADA | 20 | tonnes | $CAD/tonne |
| Cotton | Cotton | ICE-US | 50,000 | lbs. | U.S. cents/pound |
| Feeder Cattle | Feeder Cattle | CME | 50,000 | lbs. | U.S. cents/pound |
| Live Cattle | Live Cattle | CME | 40,000 | lbs. | U.S. cents/pound |
| Lean Hogs | Lean Hogs | CME | 40,000 | lbs. | U.S. cents/pound |

TABLE 2

| | Commodity | | |
|---|---|---|---|
| Commodity Name | Symbol | Allowed Contracts | Max. Tenor |
| Soybeans | S | January, March, May, July, August, September, November | 12 |
| Corn | C | March, May, July, September, December | 12 |
| Soft Red Winter Wheat | W | March, May, July, September, December | 7 |
| Hard Red Winter Wheat | KW | March, May, July, September, December | 5 |
| Bean Oil | BO | January, March, May, July, August, September, October, December | 7 |
| Soybean Meal | SM | January, May, May, July, August, September, October, December | 7 |
| Coffee | KC | March, May, July, September, December | 7 |
| Cocoa | CC | March, May, July, September, December | 7 |
| Sugar | SB | March, May, July, October | 7 |
| Canola | RS | January, March, May, July, November | 5 |
| Cotton | CT | March, May, July, December | 7 |
| Feeder Cattle | FC | January, March, April, May, August, September, October, November | 5 |
| Live Cattle | LC | February, April, June, August, October, December | 5 |
| Lean Hogs | LH | February, April, June, July, August, October, December | 5 |

Prior to the end of each month, SummerHaven Indexing determines the composition of the Agriculture Index. Values of the Agriculture Index are computed and disseminated approximately every fifteen (15) seconds from 8:00 a.m. to 5:00 p.m., New York City time, and a daily Agriculture Index Value is published at approximately 5:30 p.m., New York City time, under the index ticker symbol “SDAI TR”. Only settlement and last-sale prices are used in the Agriculture Index's calculation; bids and offers are not recognized, including limit-bid and limit-offer price quotes. Where no last-sale price exists, typically in the more deferred contract months, the previous day settlement price is used. This means that the underlying Agriculture Index may lag its theoretical value. This tendency to lag is evident at the end of the day when the Agriculture Index value is based on the settlement prices of the Benchmark Component Agriculture Futures Contracts, and explains why the underlying Agriculture Index often closes at or near the high or low for the day.

### Currency Conversion

Canola seed futures trade on the ICE Futures Canada and are denominated in Canadian dollars, Canola futures prices are divided by the USD/CAD foreign exchange spot price for purposes of index calculation and commodity weighting calculations. The USD/CAD price used for canola futures for the daily Agriculture Index value is the 3:00 p.m. EST USD/CAD price quoted by Bloomberg under currency ticket “USDCAD F150.”

### Contract Expirations

Because the Agriculture Index is comprised of actively traded contracts with scheduled expirations, it can be calculated only by reference to the prices of contracts for specified expiration, delivery or settlement periods, referred to as contract expirations. The contract expirations included in the Agriculture Index for each commodity during a given year are designated by SummerHaven Indexing, provided that each contract must be an active contract. An active contract for this purpose is a liquid, actively-traded contract expiration, as defined or identified by the relevant trading facility or, if no such definition or identification is provided by the relevant trading facility, as defined by standard custom and practice in the industry.

If a Futures Exchange ceases trading in all contract expirations relating to a particular Benchmark Component Agriculture Futures Contract, a replacement contract can be designated on the particular agricultural commodity. The replacement contract must satisfy the eligibility criteria for inclusion in the Agriculture Index. To the extent practicable, the replacement will be effected during the next monthly review of the composition of the Agriculture Index.

If a Benchmark Component Agriculture Futures Contract is eliminated and there is no replacement contract, the underlying agricultural commodity will necessarily drop out of the Agriculture Index and may be replaced.

### Commodity Weighting

Each of the Benchmark Component Agriculture Futures Contracts will remain in the Agriculture Index from month to month. Weights for each of the Benchmark Component Agriculture Futures Contracts in the Agriculture Index are determined for the next month. The methodology used to calculate the Agriculture Index weighting is based solely on quantitative data using observable futures prices and is not subject to human bias.

The monthly weighting selection is a three-step process based upon examination of the relevant futures prices for each agricultural commodity:

1) The annualized percentage price difference between the closest-to-expiration Benchmark Component Agriculture Futures Contract and the next closest-to-expiration Benchmark Component Agriculture Futures Contract is calculated for each of the 14 eligible agricultural commodities on the Selection Date. The four agricultural commodities with the highest percentage price difference are selected. A hypothetical example is included below, with the three selected commodities shaded below (the selected agricultural commodities arc ranked 1-4):

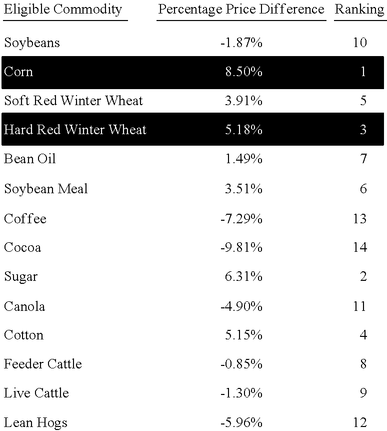

2) For the remaining 10 eligible agricultural commodities, the percentage price change of each agricultural commodity over the previous year is calculated, as measured by the change in the price of the closest-to-expiration Benchmark Component Agriculture Futures Contract on the Selection Date from the price of the closest-to-expiration Benchmark Component Agriculture Futures Contract a year prior to the Selection Date. The three agricultural commodities with the highest percentage price change are selected. A hypothetical example is included below, with the next two selected agricultural commodities shaded below (the selected agricultural commodities are ranked 1-3):

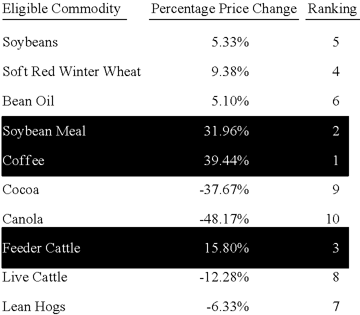

3) For the seven commodities selected through basis (step 1) and momentum (step 2), each commodity weight is increased by 2% above its base weighting for the following month. For the remaining seven commodities not selected, each commodity weight is decreased by 2% below its base weighting for the following month. A hypothetical example is included below, with the live selected commodities shaded below:

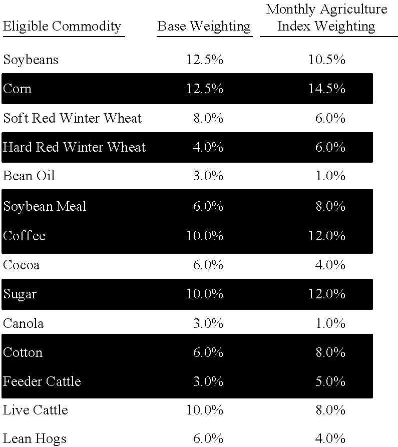

Due to the dynamic monthly agricultural commodity weighting calculation, the individual agricultural commodity weights will vary over time, depending on the price observations each month. The Selection Date for the Agriculture Index is the fifth business day prior to the first business day of the next calendar month.

FIG. 1 shows the agricultural commodity weights of the agricultural commodities selected for inclusion in the Agriculture Index as of November 2010.

### Contract Selection

For each agricultural commodity in the Agriculture Index, the index selects a specific Benchmark Component Agriculture Futures Contract with a tenor (i.e., contract month) among the eligible tenors (the range of contract months) based upon the relative prices of the Benchmark Component Agriculture Futures Contracts within the eligible range of contract months. The previous notwithstanding, the contract expiration is not changed for that month if a Benchmark Component Agriculture Futures Contract remains in the Agriculture Index, as long as the contract docs not enter expire or enter its notice period in the subsequent month.

### Portfolio Construction

The portfolio rebalancing takes place during the Rebalancing Period. At the end of each of the days in the Rebalancing Period, one fourth of the prior month portfolio positions are replaced by the new commodity weights for the commodity contracts determined on the Selection Date.

### Currency Conversion

Canola futures are denominated and quoted in Canadian dollars.

### Agriculture Index Return Calculation

The percentage excess return equals the percentage change of the market values of the underlying Benchmark Component Agriculture Futures Contracts. During the Rebalancing Period, the Agriculture Index changes its contract holdings and weightings during a four day period.

The value of the SDAI Excess Return (“SDAI ER”) at the end of a business day “t” is equal to the SDAI ER value on day “t-1” multiplied by the sum of the daily percentage price changes of each commodity future factoring in each respective commodity future's notional holding on day “t-1.”

### Rebalancing Period

The Agriculture Index is rebalanced during the last 4 business days of each calendar month, when existing positions are replaced by new positions and weightings based on the signals used for contract selection as outlined above.

### Total Return Calculation

The value of the SDAI Total Return (“SDAI TR”) on any business day is equal to the product of (i) the value of the SDAI TR on the immediately preceding business day multiplied by (ii) one plus the sum of the day's SDAI ER returns and one business day's interest from a hypothetical U.S. Treasury Bill portfolio based on the weekly Auction Rate for 3-month U.S. Treasury Bills. The value of the SDAI TR will be is calculated and published daily.

### Agriculture Index Base Level

The SDAI TR was set to 100 on Jan. 2, 1991.

### BRIEF DESCRIPTION OF THE DRAWINGS

FIG. 1 shows the SDAI commodity weights of the agricultural commodities selected for inclusion in the Agricultural Index as of November 2010, and

FIGS. 2a, 2b and 3a-3h represent example calculations of the inventive Agricultural Index.

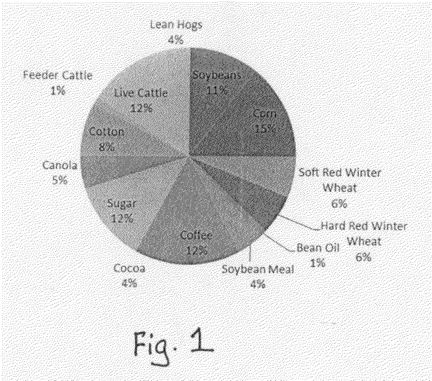

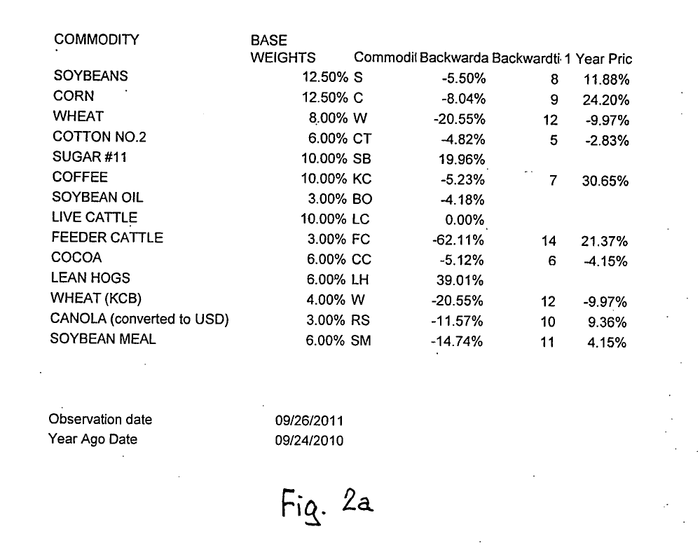

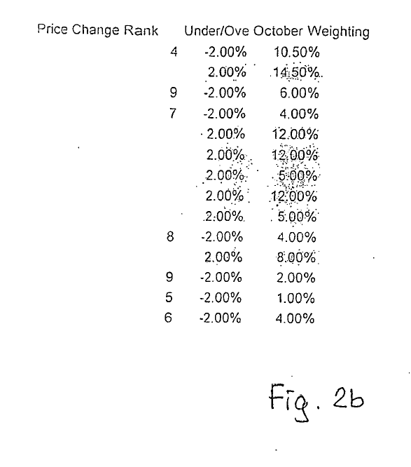

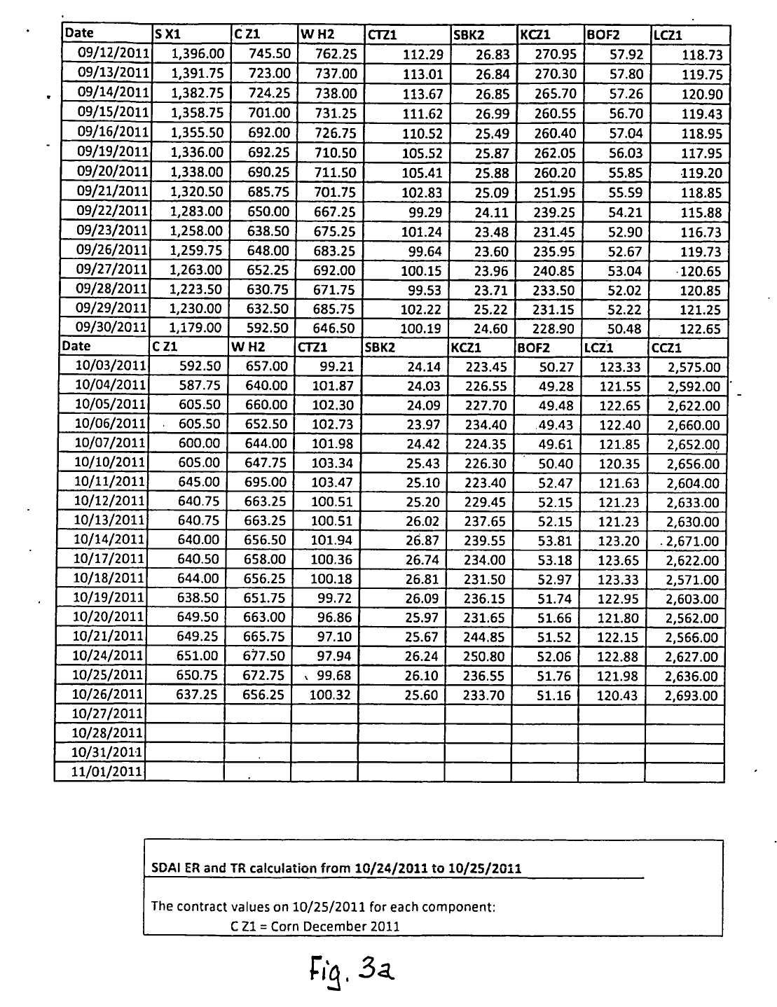

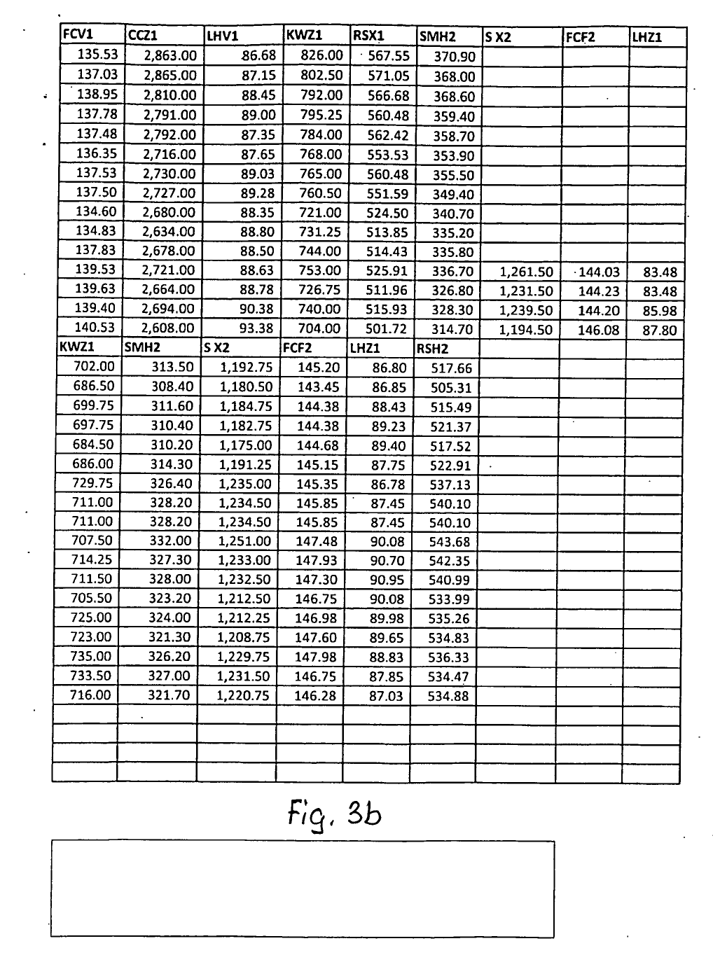

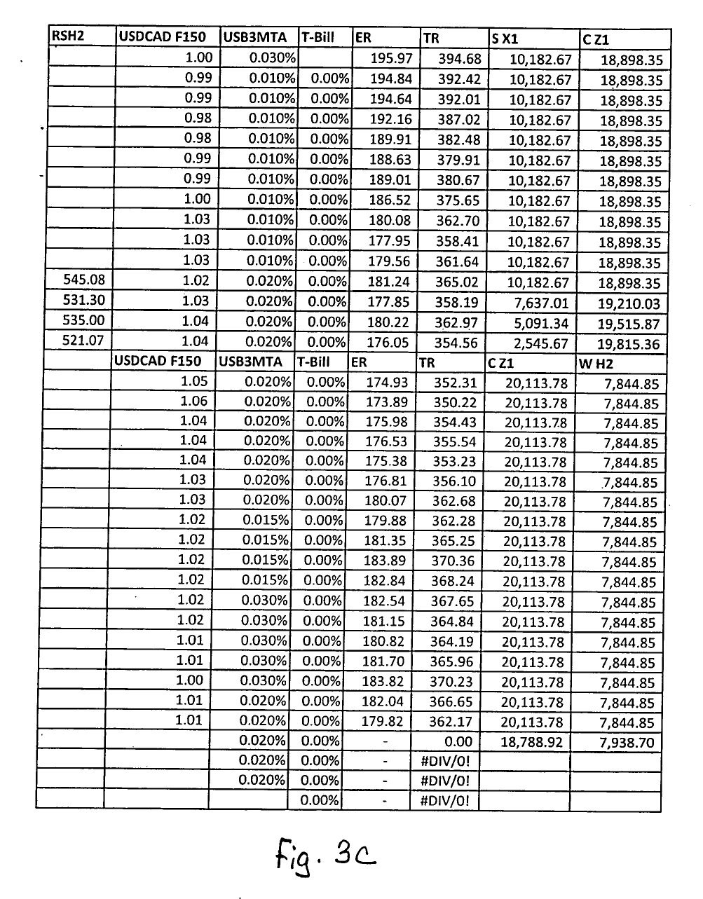

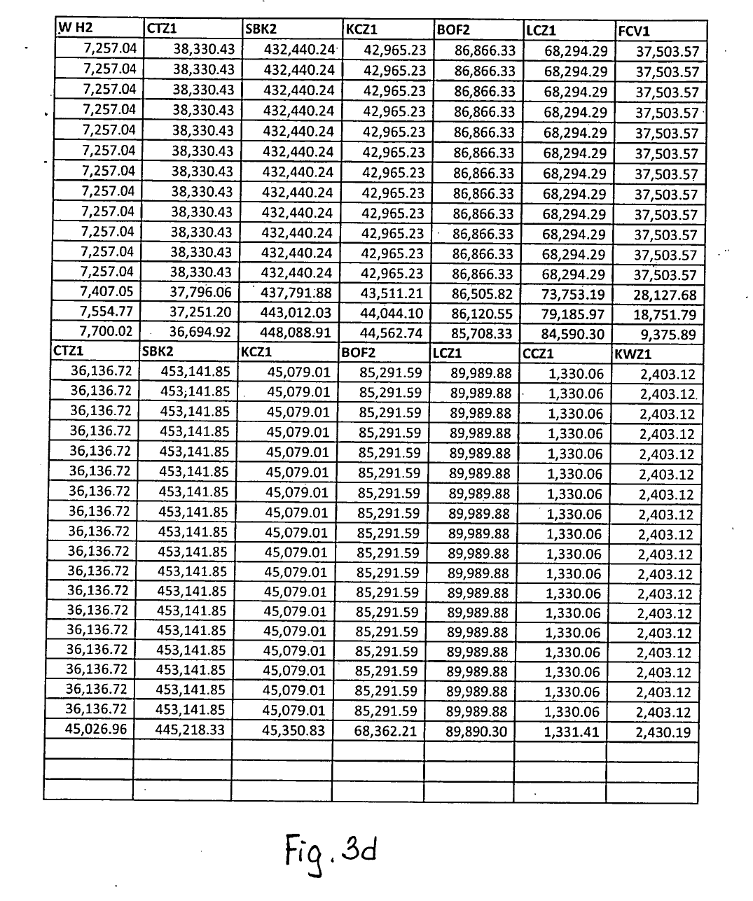

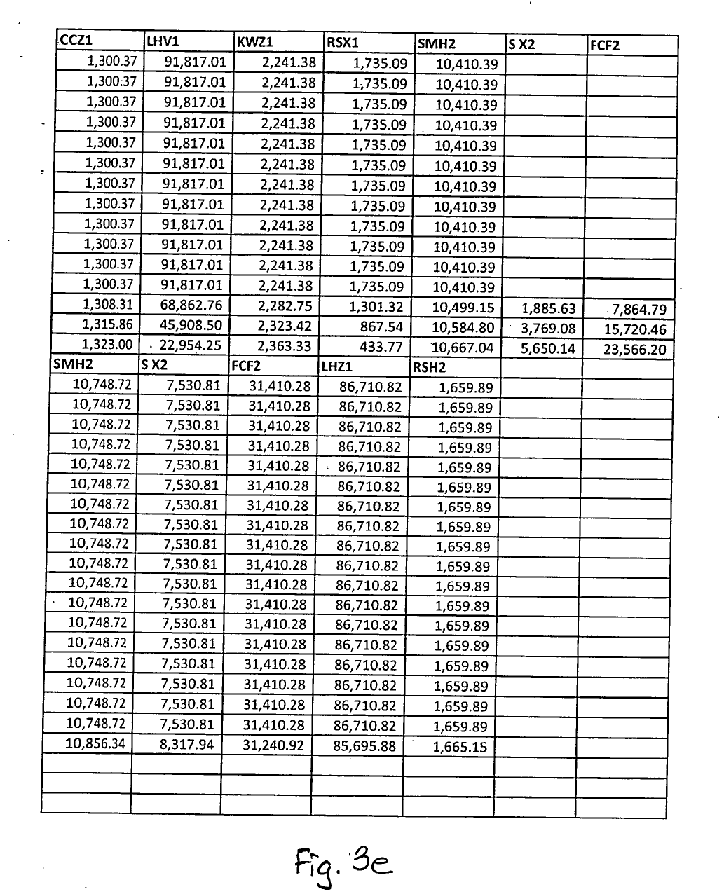

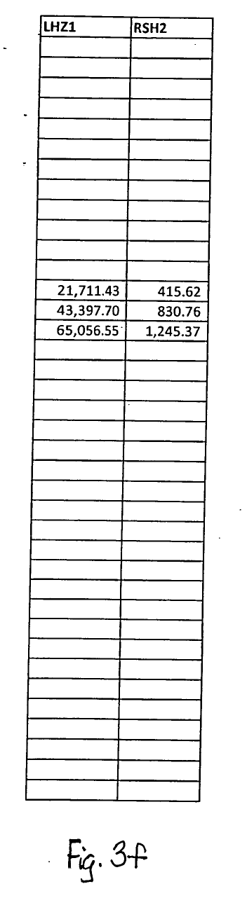

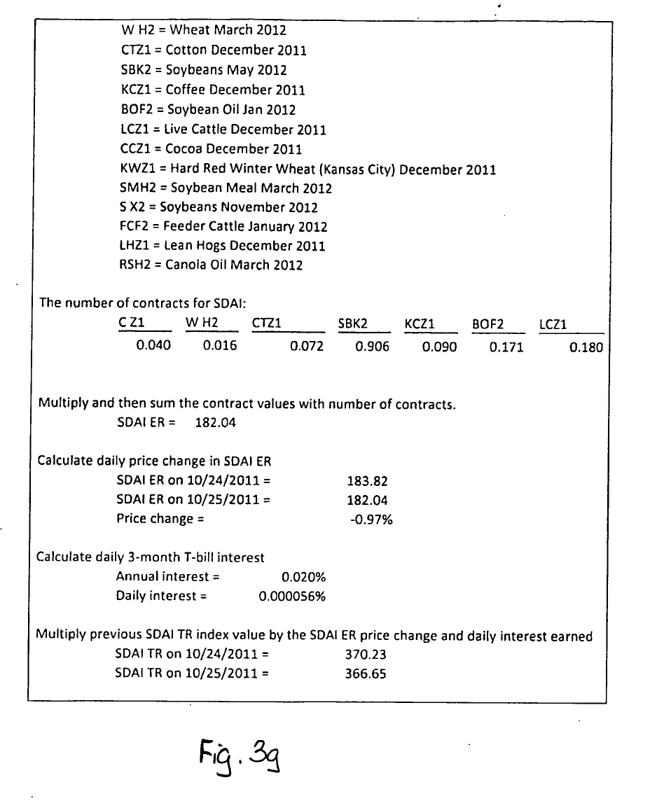

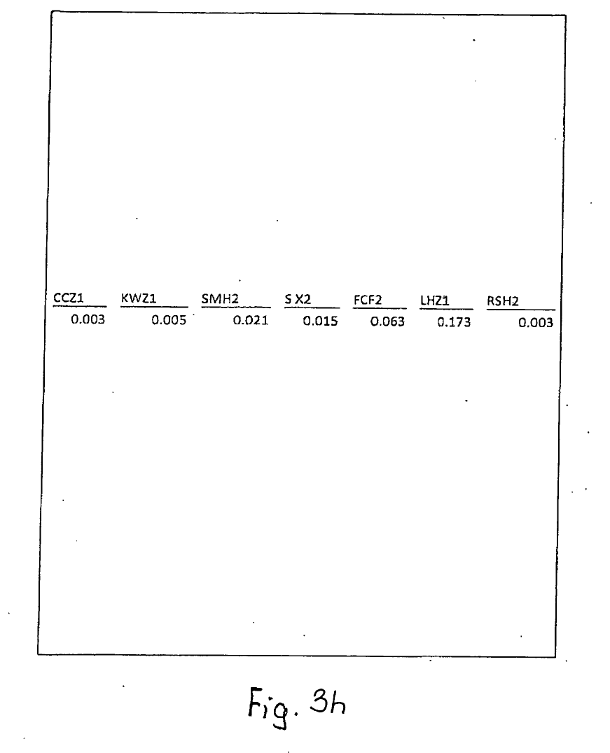

1. (canceled)

2. A method, using a computer, of providing an agricultural commodity index for investors which comprises the steps of:
(a) determining the annualized percentage price difference between the closest-to-expiration Benchmark Component Agricultural Futures Contract for each of the fourteen eligible agricultural commodities in the group consisting of soybeans, corn, soft red winter wheat, hard red winter wheat, bean oil, soybean meal, coffee, cocoa, sugar, canola, cotton, feeder cattle, live cattle and lean hogs,
(b) selecting the four agricultural commodities from said fourteen eligible agricultural commodities which have the highest price percentage price difference,
(c) from the remaining ten agricultural commodities, calculating the percentage price change of each over the previous year, as measured by the change in the price of the closest-to-expiration Benchmark Component Agricultural Futures Contract on the selection date from the price of the closest-to-expiration Benchmark Component Agricultural Futures Contract a year earlier,
(d) selecting the three agricultural commodities in step (c) which have the highest price change,
(e) for the seven commodities obtained in steps (b) and (d), increasing the commodities weight by 2% above its base weighting for the following month, and for the remaining seven commodities decreasing the commodity weight by 2% below its base weighting for the following month, the base weights in November 2010 being as follows: soybeans—10.5%, corn—14.5%, soft red winter wheat—6%, hard red winter wheat—6%, bean oil—1%, soybean meal—4%, coffee—12%, cocoa—4%, sugar—12%, canola—5%, cotton—8%, feeder cattle—1%, live cattle—12%, and lean hogs—4%,
(f) determining percentage excess return from the percentage change of market values of the underlying Benchmark Component Agricultural Futures Contracts,
(g) determining Excess Return, and
(h) determining Total Return by multiplying the value of Total Return on the immediately preceding day by one plus the sum of the day's Excess Return and one business day's interest from a hypothetical Treasury Bill portfolio based on the weekly Auction Rate for 3-month U.S. Treasury Bills.
